(19) United States
(12) Patent Application Publication
(10) Pub. No.: US 2020/0192946 A1
(43) Pub. Date: Jun. 18, 2020

(54) DOCUMENT PROCESSING DEVICE AND DOCUMENT PROCESSING PROGRAM

(71) Applicant: KONICA MINOLTA, INC., Tokyo (JP)

(72) Inventor: Kazuaki KANAI, Tokyo (JP)

(73) Assignee: KONICA MINOLTA, INC., Tokyo (JP)

(21) Appl. No.: 16/682,633

(22) Filed: Nov. 13, 2019

(30) Foreign Application Priority Data
Dec. 13, 2018 (JP) 2018-233261

(51) Int. Cl. G06F 16/93; G06F 16/33; G06F 16/338

(52) U.S. Cl. CPC G06F 16/93; G06F 3/0482; G06F 16/338; G06F 16/334

(57) ABSTRACT

Provided are a document processing device and a non-transitory recording medium storing a computer readable program in which it is possible to search for a part similar to a part selected by a user in one document from another document mutually related to the above document. The document processing device comprising: a storage unit that stores plurality of documents related to each other; a hardware processor that: causes a user to select a part of a content of a first document among the plurality of documents stored in the storage unit; searches for a part similar to the selected part of the content of the first document, from documents other than the first document among the plurality of documents; and notifies of a first part which has been found and is similar to the selected part of the content of the first document.

### CROSS-REFERENCE TO RELATED APPLICATION

The entire disclosure of Japanese Patent Application No. 2018-233261, filed on Dec. 13, 2018, is incorporated herein by reference in its entirety.

### BACKGROUND

### 1. Technological Field

The present invention relates to a document processing device and a document processing program.

### 2. Description of the Related Art

Companies are required to efficiently prepare and confirm daily reports, weekly reports, and other periodic reports. For example, business reports from subordinates to superiors are regularly performed in the form of daily reports or weekly reports, in many cases.

The report includes details such as the progress of initiatives for issues and the occurrence of problems, and reports on the same issues and problems multiple times using a PDCA (Plan, Do, Check, Act) cycle, and the like. For example, for one issue, in a case where it is not possible to solve a problem in a single reporting period, the subordinate reports the progress to the supervisor multiple times. In this case, the report may not include the previously reported content, and the supervisor needs to memorize the previous reported content.

However, in a case where a supervisor has a plurality of subordinates, it is normally difficult for the supervisor to memorize the contents of the previous reports of the plurality of subordinates over a long period of time. For example, it is assumed that a subordinate reports to a supervisor that a project has 4 digested work units (total work unit is 5), in this weekly report. On the other hand, the supervisor can read this weekly report and immediately grasp that 4 of 5 work units in total have been digested. However, in a case where the supervisor does not memorize the work units which have been digested last week, the supervisor does not know the number of digested work units from the last week to this week. In such a case, the supervisor needs to make inquiries to the subordinate or to check the previous report, and this takes time and effort. In addition, the subordinate may forget the previous reported content even though the supervisor performs an inquiry to the subordinate. Thus, it is also necessary to check the previous report, and this takes time and effort. In a case where the supervisor checks the previous report of the subordinate, the supervisor searches for the content similar to the content reported in this weekly report, from the previous report.

Regarding this, for example, a technology of comparing the paragraphs of one document of two specific documents with the paragraphs or chapters of the other document to calculate similarity is disclosed in Japanese Patent Application Laid-Open No. 2015-219799.

### SUMMARY

However, in the technology disclosed in Japanese Patent Application Laid-Open No. 2015-219799, similarity of the paragraph or the chapter between the two specific documents is calculated. Thus, it is not considered that a part similar to a part selected by a user in one document is searched from the other document.

The present invention has been made in view of the above circumstances, and an object thereof is to provide a document processing device and a document processing program in which it is possible to search for a part similar to a part selected by a user in one document from another document mutually related to the above document.

To achieve at least one of the above-mentioned objects, according to an aspect of the present invention, a document processing device reflecting one aspect of the present invention comprises a storage unit that stores a plurality of documents related to each other, a selection unit that causes a user to select a part of a content of a first document among the plurality of documents stored in the storage unit, a searching unit that searches for a part similar to the selected part of the content of the first document, from documents other than the first document among the plurality of documents, and a notification unit that performs a notification of a first part which has been found by the searching unit and is similar to the selected part of the content of the first document.

To achieve at least one of the above-mentioned objects, according to another aspect of the present invention, a document processing program reflecting another aspect of the present invention causes a document processing device to execute a procedure (a) of causing a user to select a part of a content of a first document registered in the document processing device, a procedure (b) of searching for a part similar to the selected part of the content of the first document from documents other than the first document among a plurality of documents which are registered in the document processing device and relate to each other, and a procedure (c) of performing a notification of a first part which has been found in the procedure (b) and is similar to the selected part of the content of the first document.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic block diagram illustrating a configuration of a document processing system according to an embodiment;

FIG. 2 is a schematic block diagram illustrating a hardware configuration of a user terminal illustrated in FIG. 1;

FIG. 3 is a functional block diagram illustrating a functional configuration of the document processing device illustrated in FIG. 1;

FIG. 4 is a flowchart illustrating an outline of a document processing method according to an embodiment;

FIG. 5 is a schematic diagram illustrating an example of a report displayed in a display of the user terminal;

FIG. 6 is a subroutine flowchart illustrating details of an example of a method (step S102) of searching for a part similar to a confirmation sentence in Example 1;

FIG. 7A is a schematic diagram illustrating a syntactic analysis of a first report;

FIG. 7B is a schematic diagram illustrating a syntactic analysis of a second report;

FIG. 8A is a schematic diagram illustrating determination of a similar title;

FIG. 8B is a schematic diagram illustrating the determination of the similar title;

FIG. 9A is a schematic diagram illustrating determination of a similar body;

FIG. 9B is a schematic diagram illustrating the determination of the similar body;

FIG. 10 is a subroutine flowchart illustrating details of an example of a method (step S102) of searching for a part similar to a confirmation sentence in Example 2;

FIG. 11A is a schematic diagram illustrating determination of a similar body;

FIG. 11B is a schematic diagram illustrating the determination of the similar body;

FIG. 11C is a schematic diagram illustrating the determination of the similar body;

FIG. 12 is a schematic diagram illustrating an example of a method of displaying a determination sentence using a pop-up window in Example 3;

FIG. 13 is a schematic diagram illustrating another example of the method of displaying a determination sentence using a pop-up window in Example 3;

FIG. 14 is a schematic diagram illustrating still another example of the method of displaying a determination sentence using a pop-up window in Example 3;

FIG. 15 is a schematic diagram illustrating a case where all determination sentences are displayed in Example 4;

FIG. 16 is a schematic diagram illustrating an example of a method of displaying the determination sentence using another window in Example 5;

FIG. 17 is a schematic diagram illustrating an example of a display in a case where it is not possible to find a part similar to the confirmation sentence in Example 6; and

FIG. 18 is a schematic diagram illustrating another example of the display in a case where it is not possible to find a part similar to the confirmation sentence in Example 6.

### DETAILED DESCRIPTION OF EMBODIMENTS

Hereinafter, one or more embodiments of the present invention will be described with reference to the drawings. However, the scope of the invention is not limited to the disclosed embodiments.

### One Embodiment

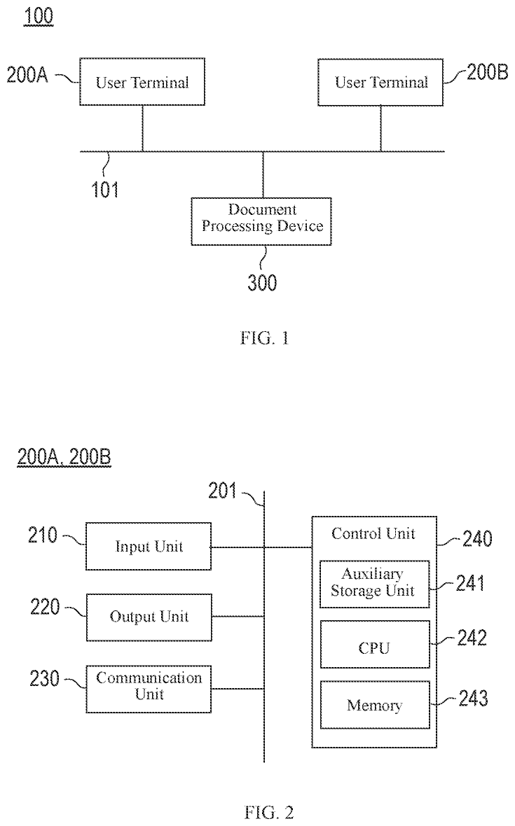

FIG. 1 is a schematic block diagram illustrating a configuration of a document processing system 100 according to an embodiment. FIG. 2 is a schematic block diagram illustrating a hardware configuration of user terminals 200A and 200B illustrated in FIG. 1.

<Document Processing System 100>

As illustrated in FIG. 1, the document processing system 100 includes user terminals 200A and 200B and a document processing device 300, which are connected to each other via a network 101 so as to enable communication with each other.

The network 101 includes a LAN (Local Area Network) in which network devices including the user terminals 200A and 200B and the document processing device 300 are connected to each other, or a WAN (Wide Area Network) in which the LANs are connected to each other by a dedicated line, and the like.

<User Terminals 200A, 200B>

As illustrated in FIG. 2, the user terminals 200A and 200B are, for example, information terminals such as a personal computer and a smartphone. Each of the user terminals includes an input unit 210, an output unit 220, a communication unit 230, and a control unit 240.

The input unit 210 receives an input of a user and transmits the input to the control unit 240. The input unit 210 includes, for example, a keyboard, a pointing device such as a mouse, a touch panel display, and the like, and receives character input, position information input, various settings, various instructions, and the like from a user.

The output unit 220 includes, for example, a display, and displays various pieces of information such as a screen for receiving a user input, various setting screens, a document editing screen, and processing results. The output unit 220 can also include a speaker and the like.

The communication unit 230 includes a communication interface, and transmits and receives data to and from the document processing device 300.

The control unit 240 includes an auxiliary storage unit 241, a CPU (Central Processing Unit) 242, and a memory 243. The CPU 242 realizes various functions by executing an OS (Operating System) and various kinds of application software. The application software includes a word processing application, a spreadsheet application, a drawing application, and the like. The OS and various kinds of application software are stored in the auxiliary storage unit 241.

The memory 243 includes a RAM (Random access memory) and a ROM (Read Only Memory). The application software is loaded from the auxiliary storage unit 241 onto the RAM when executed by the CPU 242. Processing results and calculation results by the CPU 242 are stored in the RAM. Various parameters and the like required when the OS is executed are stored in the ROM.

It is assumed below that a user B (for example, a supervisor) of the user terminal 200B confirms a report (document) created by the user A (for example, a subordinate) on the user terminal 200A. The user A creates a report using application software on the user terminal 200A, and transmits the report to the document processing device 300. The user B operates the user terminal 200B to confirm the report stored in the document processing device 300.

<Document Processing Device 300>

The document processing device 300 is a computer or a server, and has an input unit, an output unit, a communication unit, and a control unit, similar to the user terminals 200A and 200B. The control unit includes an auxiliary storage unit, a CPU, and a memory. Since the components have the same configuration as that of the user terminals 200A and 200B, description thereof will be omitted. The document processing device 300 may be an information terminal equivalent to the user terminals 200A and 200B, for example, a personal computer.

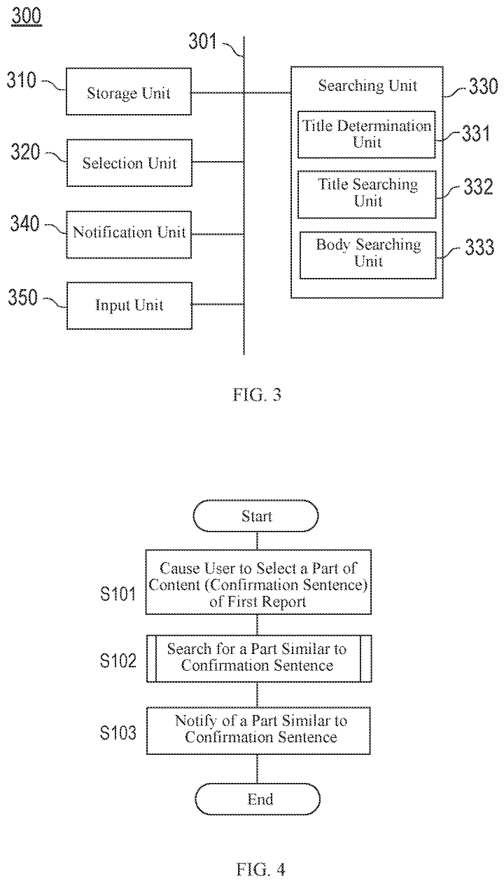

FIG. 3 is a functional block diagram illustrating a functional configuration of the document processing device 300 illustrated in FIG. 1. The document processing device 300 includes a storage unit 310, a selection unit 320, a searching unit 330, and a notification unit 340. The storage unit 310 is configured by the auxiliary storage unit of the control unit and a RAM. The selection unit 320, the searching unit 330, and the notification unit 340 are realized by the CPU (hardware processor) of the control unit executing a document processing program.

The storage unit 310 stores a plurality of documents. As will be described later, some of the plurality of documents relate to each other, such as, for example, a past weekly report and a this weekly report.

For example, the user A creates a report using a document creation application or the like on the user terminal 200A, and transmits the report to the document processing device 300. The data of the transmitted report is stored in the storage unit 310. In this specification, transmitting a report created by a user to the document processing device 300 and storing the report in the storage unit 310 is referred to as “registration” below.

The storage unit 310 accumulates documents such as reports of a plurality of users including the user A every day. The document management form in the storage unit 310 may be a form in which each user manages a document name and a folder name, or may be a form in which documents of all user are centrally managed by dedicated file management software. A series of reports such as daily reports and weekly reports, which relate to each other may be managed so that a part of the file name is shared. Further, the document processing device 300 may have a recording file in the storage unit 310. The recording file is used for associating and recording documents related to each other.

The selection unit 320 causes the user B to select a part of the content of a specific report among a plurality of registered documents, for example. The specific report is a report that needs to be confirmed by the user B, and may be designated by the user B, or may be designated by the user A or another user. The part of the content may mean, for example, one or more sentences or sections. The selection unit 320 causes the display of the user terminal 200B to display a specific report and urges the user B to select a part of the specific report, which needs to be confirmed.

The searching unit 330 searches for a part similar to the part of the content from documents other than the specific report among the plurality of registered documents. The searching unit 330 includes a title determination unit 331, a title searching unit 332, and a body searching unit 333. Details of the components will be described later.

The notification unit 340 performs a notification of a part which has been found by the searching unit 330 and is similar to the part of the content. More specifically, the notification unit 340 performs the notification, for example, in a manner that the notification unit 340 transmits the found part similar to the part of the content to the user terminal 200B and causes the found part to be displayed in the display of the user terminal 200B.

<Document Processing Method>

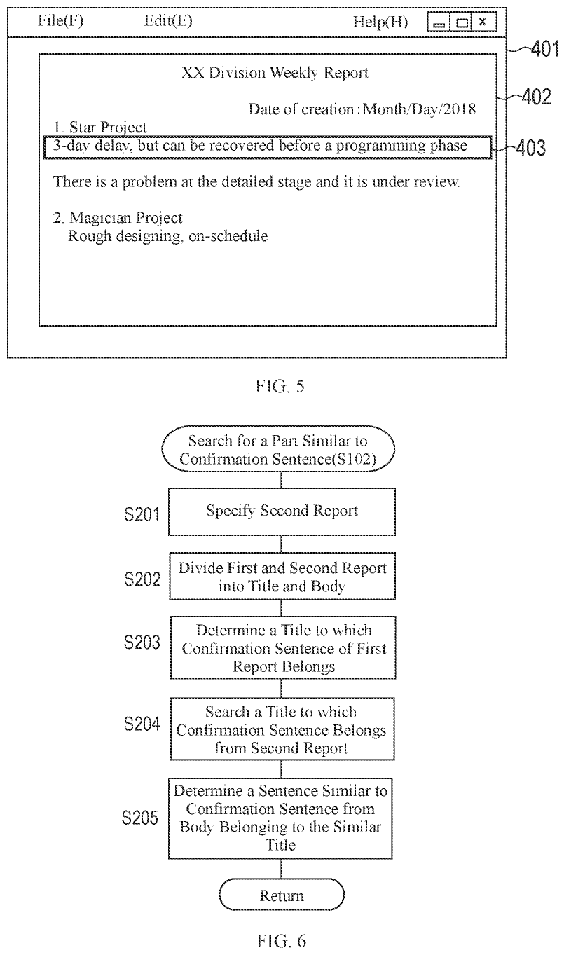

An outline of a document processing method performed by the document processing device 300 will be described below with reference to FIG. 4. FIG. 4 is a flowchart illustrating the outline of the document processing method in the embodiment. FIG. 5 is a schematic diagram illustrating an example of a report displayed in the display of the user terminal 200B. The process in the flowchart illustrated in FIG. 4 is realized by the CPU of the control unit of the document processing device 300 executing the document processing program.

Firstly, a user is caused to select a part of the content of a report (step S101). For example, the user B operates the user terminal 200B and designates a first report (first document) that needs to be confirmed. The selection unit 320 reads the data of the designated first report from the storage unit 310 and transmits the data to the user terminal 200B. As illustrated in FIG. 5, the user terminal 200B displays the contents of the first report 402 in a window 401 on the screen of the display. Subsequently, the user B selects a sentence or a section (referred to as “a confirmation sentence” below) to be confirmed, from the content of the first report 402 displayed on the screen of the display. FIG. 5 illustrates a case where a confirmation sentence 403 that “3 days are delayed, but recovery can be performed before a programming phase” is selected. The confirmation sentence is selected, for example, by designating a range of the displayed sentence using the pointing device such as a mouse or the touch panel display.

Then, a part similar to the confirmation sentence 403 is searched for (step S102). The searching unit 330 searches for a part similar to the selected confirmation sentence 403 in a second report (second document) being a document related to the first report 402 from documents other than the first report 402 among the registered documents. A specific example of a searching method will be described later.

Then, a notification of the part similar to the confirmation sentence 403 is performed (step S103). The notification unit 340 performs the notification by causing the display of the user terminal 200B to display the part (first part) of the second report, which is similar to the selected confirmation sentence 403. If necessary, the notification of the part similar to the confirmation sentence 403 can be performed by sound with a speaker.

As described above, according to the flowchart illustrated in FIG. 4, the user is caused to select a part of the content of the first report 402 as the confirmation sentence 403. Subsequently, the document processing device 300 searches for a part similar to the selected confirmation sentence 403 in the registered second report in relation to the first report 402, and performs a notification of the part similar to the confirmation sentence 403.

### EXAMPLE 1

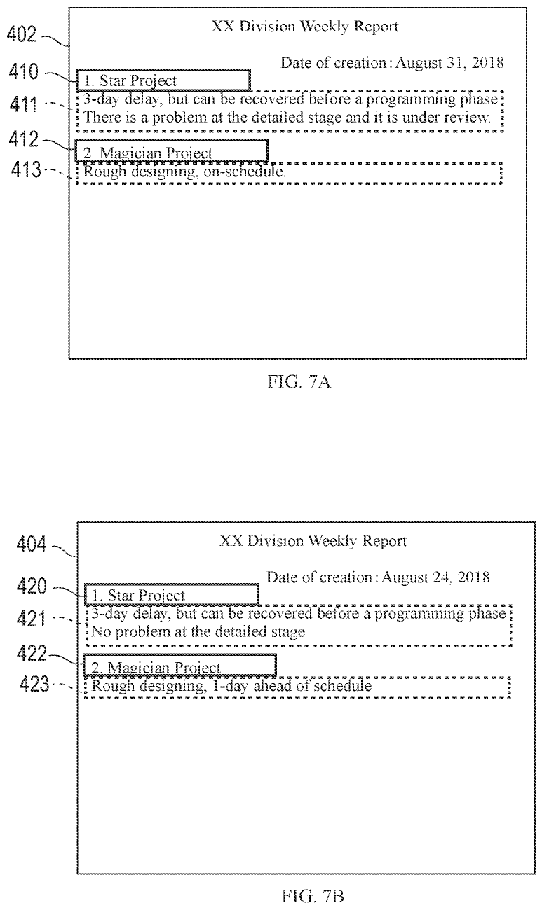

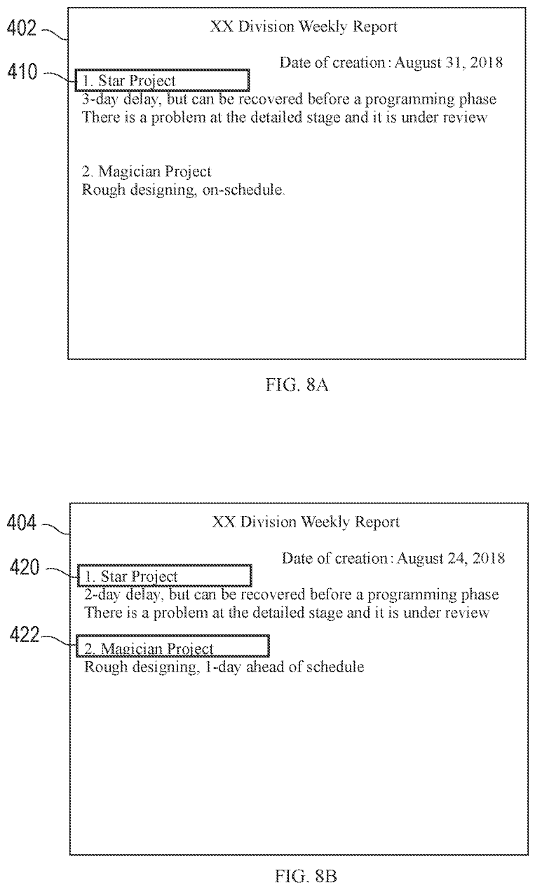

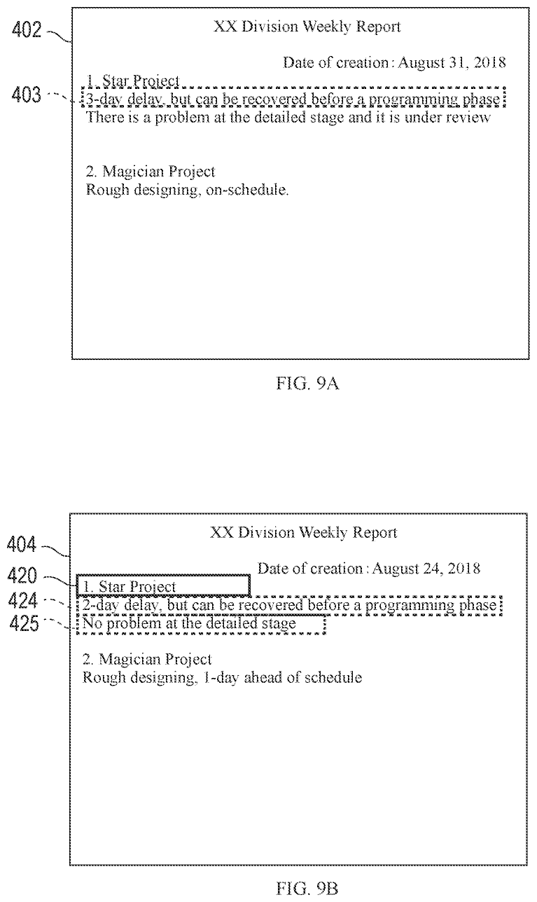

Next, an example of a method for searching for a part similar to the confirmation sentence 403 will be described with reference to FIGS. 6 to 9B. FIG. 6 is a subroutine flowchart illustrating details of an example of a method (step S102) of searching for a part similar to the confirmation sentence 403 in Example 1. The process in the subroutine flowchart illustrated in FIG. 6 is realized by the CPU of the control unit of the document processing device 300 executing the document processing program. FIGS. 7A and 7B are schematic diagrams illustrating syntactic analysis of the first and second reports, respectively. FIGS. 8A and 8B are schematic diagrams illustrating determination of a similar title. FIGS. 9A and 9B are schematic diagrams illustrating determination of a similar body.

In Example 1, it is presumed that the content of the report includes a body and a title to which the body belongs. The body contains at least one sentence or section. It is assumed that the confirmation sentence 403 is selected from the body of the first report 402.

The document processing device 300 determines a title to which the confirmation sentence 403 of the first report 402 belongs, and searches for a title similar to the determined title from the second report. The second report may be, for example, the most recent report of previous reports. Furthermore, the document processing device 300 searches for a part (first part) similar to the confirmation sentence 403 of the first report 402, from the body belonging to the title found in the second report. In Example 1, for example, the first report 402 is this weekly report, and the second report is the previous weekly report. A more specific procedure of the searching method in Example 1 is as follows.

As illustrated in FIG. 6, firstly, the second report is specified (step S201). The searching unit 330 specifies a report date of the first report 402 based on the creation date described in the first report 402, the date included in the body (described later) of the first report 402, the date included in the file name of the first report 402, a time stamp or the like (referred to as “date information” below). Subsequently, the searching unit 330 specifies the second report 404 based on the specified report date of the first report 402 (see FIGS. 7A and 7B). In the example illustrated in FIG. 7A and FIG. 7B, the first and second reports 402 and 404 are reports with the creation dates of Aug. 31, 2018 and August 24, respectively.

Then, each of the first and second reports 402 and 404 is divided into a title and a body (step S202). As illustrated in FIG. 7A, the searching unit 330 performs syntactic analysis on the first report 402 and divides the first report 402 into a first title 410, a first body 411, a second title 412, and a second body 413. Similarly, as illustrated in FIG. 7B, the searching unit 330 also performs syntactic analysis on the second report 404, and divides the second report 404 into a third title 420, a third body 421, a fourth title 422, and a fourth body 423. Regarding the syntactic analysis, a well-known method can be employed, and thus detailed description thereof will be omitted.

Then, a title to which the confirmation sentence 403 of the first report 402 belongs is determined (step S203). The title determination unit 331 selects the title to which the confirmation sentence 403 belongs (corresponding to the confirmation sentence 403) from the first and second titles 410 and 412 obtained by performing syntactic analysis on the first report 402. For example, in a case of the example illustrated in FIG. 7A, the title to which the confirmation sentence 403 belongs is the first title 410.

Then, a title similar to the title to which the confirmation sentence 403 belongs is searched from the second report 404 (step S204). The title searching unit 332 calculates title similarity between the first title 410, and each of the third and fourth titles 420 and 422 included in the second report 404. The title searching unit 332 sets a title in which the calculated title similarity exceeds a predetermined threshold among the third and fourth titles 420 and 422 to be a title similar to the first title 410.

The title similarity can be calculated by (number of title characters−distance)/number of title characters. The number of title characters is, for example, the number of characters of the first title 410. The distance is, for example, the Levenshtein distance between the first title 410, and the third title 420 or the fourth title 422. The predetermined threshold may be 80%, for example.

For example, as illustrated in FIGS. 8A and 8B, the first title 410 (“1. Star Project”) of the first report 402 is completely identical to the third title 420 of the second report 404. Thus, in the example illustrated in FIGS. 8A and 8B, in the second report 404, a title similar to the title to which the confirmation sentence 403 of the first report 402 belongs (referred to as “a similar title” of the second report 404 below) is the third title 420. In this case, the distance is 0, and the similarity is 100%.

Then, a sentence similar to the confirmation sentence 403 is determined from the body belonging to the similar title (step S205). For example, it is considered that, in a case where the user A creates the first report 402 based on the second report 404, that is, the user A partially edits the second report 404 to reflect the work progress, there is no large difference between the bodies of the first and the second reports 402 and 404. In the present embodiment, the body searching unit 333 calculates body similarity between the confirmation sentence 403, and each sentence included in the third body 421 belonging to the third title (similar title) 420. The body similarity can be calculated by (number of body characters-distance)/number of body characters. Here, since the number of body characters and the distance are defined in the similar manner to the number of title characters and the distance, detailed description thereof will be omitted. The body searching unit 333 sets a sentence (referred to as “determination sentence” below) in the third body 421, in which the body similarity exceeds a predetermined threshold, to be a body similar to the confirmation sentence 403.

For example, as illustrated in FIGS. 9A and 9B, the confirmation sentence 403 of the first report 402 is similar to a sentence 424 that “2 days are delayed, but recovery can be performed before a programming phase”, which is included in the third body 421 belonging to the third title 420 of the second report 404. Thus, in the example illustrated in FIG. 9B, the determination sentence is the sentence 424 included in the third body 421.

In the above example, a case where the first and second reports 402 and 404 are the reports of the current week and the previous week is described. However, the example is not limited to such a case, and the second report 404 may be a report before the previous week. Even in a case where the sentence similar to the confirmation sentence 403 in this weekly report is not found from the previous weekly report or in a case where such a sentence is found, the searching unit 330 can search for the sentence similar to the confirmation sentence 403 from a report before two weeks from the previous week.

### EXAMPLE 2

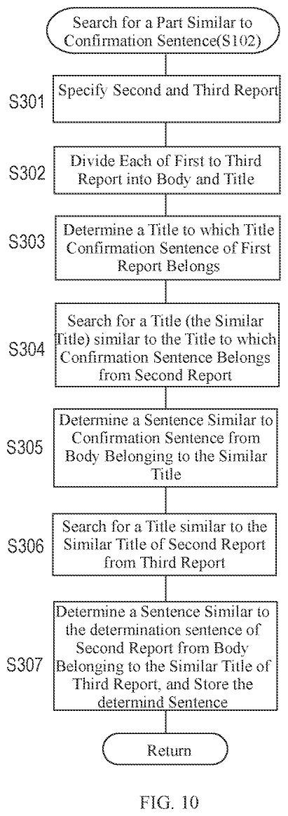

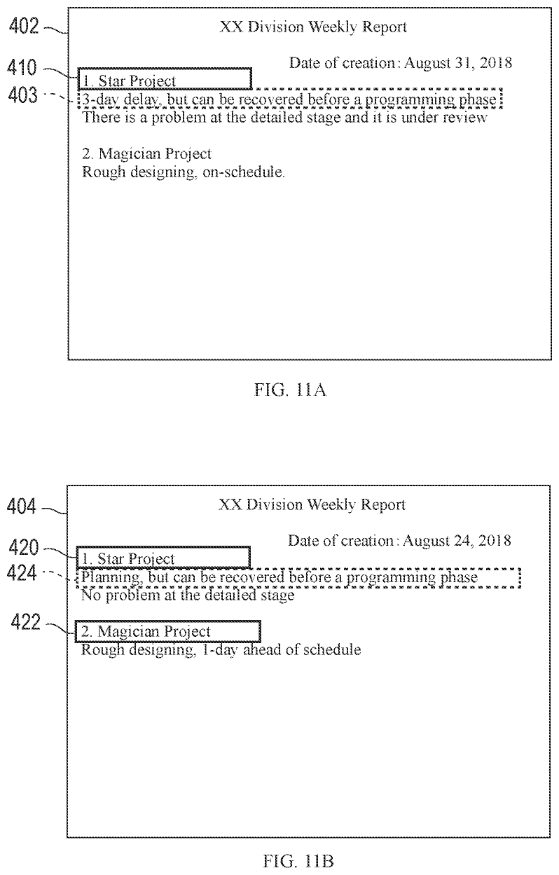

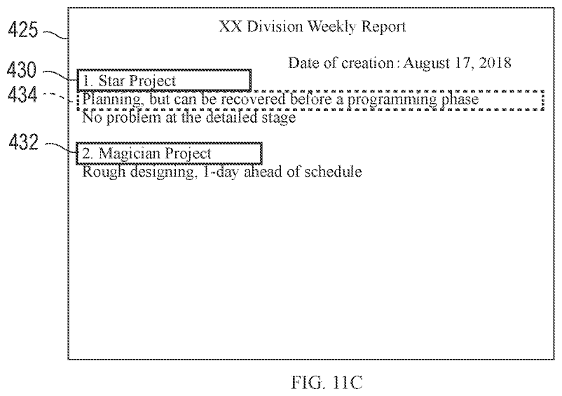

Next, another example of the method of searching for a part similar to the confirmation sentence 403 will be described with reference to FIGS. 10 to 11C. FIG. 10 is a subroutine flowchart illustrating details of an example of the method (step S102) of searching for a part similar to the confirmation sentence 403 in Example 2.The process in the subroutine flowchart illustrated in FIG. 10 is realized by the CPU of the control unit of the document processing device 300 executing the document processing program. FIG. 11A to FIG. 11C are schematic diagrams illustrating determination of a similar body.

In Example 1, the case where a sentence similar to the confirmation sentence 403 of the first report 402 is searched in reports before the second report 404 earlier than the first report 402 has been described. In Example 2, a case where a sentence similar to the determination sentence 424 of the second report 404 is searched in a third report before the second report 404 in addition to the searching in Example 1 will be described. In Example 2, the first report 402 is this weekly report, the second report 404 is the report for the previous week (one week ago), and the third report is a report for a week before two weeks.

As illustrated in FIG. 10, in the process of searching for a part similar to the confirmation sentence 403 (step S102), firstly, the second and third reports are specified (step S301). For example, the searching unit 330 specifies the report date of the first report 402 based on the date information described in the first report 402, and specifies the second report 404 based on the specified report date of the first report 402. Further, the searching unit 330 specifies the third report based on the report date of the specified second report 404. In a case where searching is performed in the fourth to the n-th reports before the third report, specifying is performed to the n-th report in the similar manner.

Then, each of the first and third reports is divided into a title and a body (step S302). The searching unit 330 performs syntactic analysis on the first to third reports, and divides each of the first to third reports into at least one title and a body belonging to the title. The body contains at least one sentence or section. In a case where searching is performed in the fourth to the n-th reports before the third report, dividing into a title and a body is performed to the n-th report in the similar manner.

Then, a title to which the confirmation sentence 403 of the first report 402 belongs is determined (step S303). The title determination unit 331 determines the title to which the confirmation sentence 403 belongs, from at least one title obtained by performing syntactic analysis on the first report 402. FIG. 11A illustrates a case where the first title 410 to which the confirmation sentence 403 belongs is determined.

Then, a title (similar title) similar to the title to which the confirmation sentence 403 belongs is searched from the second report 404 (step S304). The title searching unit 332 calculates the title similarity between the first title 410 to which the confirmation sentence 403 belongs, and the third and fourth titles 420 and 422 included in the second report 404. The title searching unit 332 sets the title of the second report 404, in which the title similarity exceeds a predetermined threshold, to be a similar title similar to the first title 410. In the example illustrated in FIG. 11B, it is determined that the third title 420 is similar to the first title 410, and the third title 420 is stored in the storage unit 310 as the similar title.

Then, a sentence similar to the confirmation sentence 403 is determined from a body belonging to the similar title and is stored (step S305). The body searching unit 333 calculates the body similarity between the confirmation sentence 403, and each sentence included in the third body 421 belonging to the third title (similar title) 420. The body searching unit 333 stores the sentence in which the body similarity exceeds a predetermined threshold, as a determination sentence. In the example illustrated in FIG. 11B, a sentence 424 that “the plan is being made, but recovery can be performed before the programming phase” is determined to be similar to the confirmation sentence 403 and is stored in the storage unit 310 as the determination sentence.

Then, a title similar to the similar title of the second report 404 is searched from the third report (step S306). The title searching unit 332 calculates the title similarity between the similar title (third title 420) of the second report 404, and a fifth title 430 and a sixth title 432 included in the third report (see FIG. 11C). The title searching unit 332 stores the fifth title 430 in which the title similarity exceeds a predetermined threshold, in the storage unit 310 as a title (similar title of the third report 425) similar to the third title 420.

Then, a sentence similar to the determination sentence 424 of the second report 404 is determined from the body belonging to the similar title of the third report 425, and is stored (step S307). The body searching unit 333 calculates the body similarity between the determination sentence 424 of the second report 404 and each sentence included in the body belonging to the similar title of the third report 425. The body searching unit 333 stores the sentence in which the body similarity exceeds a predetermined threshold, as the determination sentence. In the example illustrated in FIG. 11C, a sentence 434 that “the plan is being made, but recovery can be performed before the programming phase” is determined to be a sentence (second part) similar to the determination sentence 424 and is stored in the storage unit 310 as the determination sentence.

As described above, in Example 2, the confirmation sentence 403 of the first report 402 and the determination sentence 424 of the second report 404 are in a similar relation, and the determination sentence 424 of the second report 404 and the determination sentence 434 of the third report 425 are in a similar relation. Further, it is considered that the similarity between the confirmation sentence 403 and the determination sentence 434 is not as large as the similarity between the confirmation sentence 403 and the determination sentence 424, but has some degrees. For example, in a case where the user A creates a report for the previous week based on the report for a week before two weeks, and creates a report for the current week based on the report for the previous week, it is considered that there is no large difference between bodies of the reports for the week before two weeks and for the previous week. However, this weekly report has been edited twice from the report for a week before two weeks by the user A, and thus it is considered that a difference between the bodies is large. In the present embodiment, assuming such a case, a sentence similar to the report in comparison to the previous report (for example, the report of the previous week) is also set to be the determination sentence and is stored in the storage unit 310. Thus, the user B can also refer to the sentence similar to the confirmation sentence 403 in a report in the past such as a week before two weeks.

As described above, according to the process illustrated in FIG. 10, the searching unit 330 searches for a similar title similar to the title belonging to the confirmation sentence 403 of the first report 402, from the second report 404, and searches for a sentence similar to the confirmation sentence 403 from a body belonging to the similar title. The searching unit 330 stores the searched title and the searched sentence. Further, the searching unit 330 searches a title similar to the similar title of the second report 404 from the third report 425, searches for a sentence similar to the determination sentence 424 of the second report 404 from a body belonging to the similar title of the third report 425, and stores the searched title and the searched sentence. Searching can be performed on the fourth to the n-th reports before the third report 425 in the similar manner. In this case, similar to the case of searching up to the third report 425, the searching unit 330 searches for the similar title up to the n-th report, searches for a sentence similar to the determination sentence of a report after one week from a body belonging to the similar title, and stores the searched title and the searched sentence.

### EXAMPLE 3

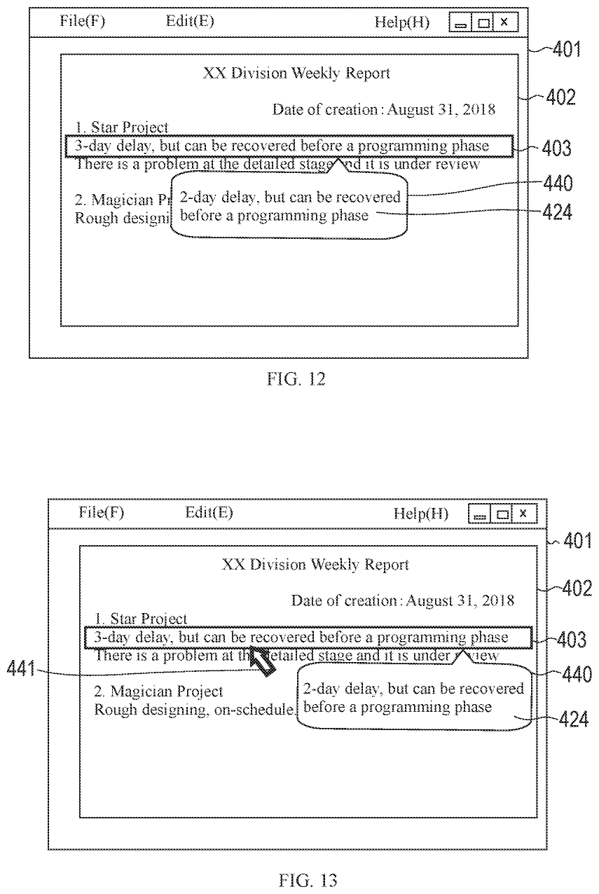

A method of displaying the determination sentence with a pop-up window in Example 3 will be described with reference to FIGS. 12 to 14.

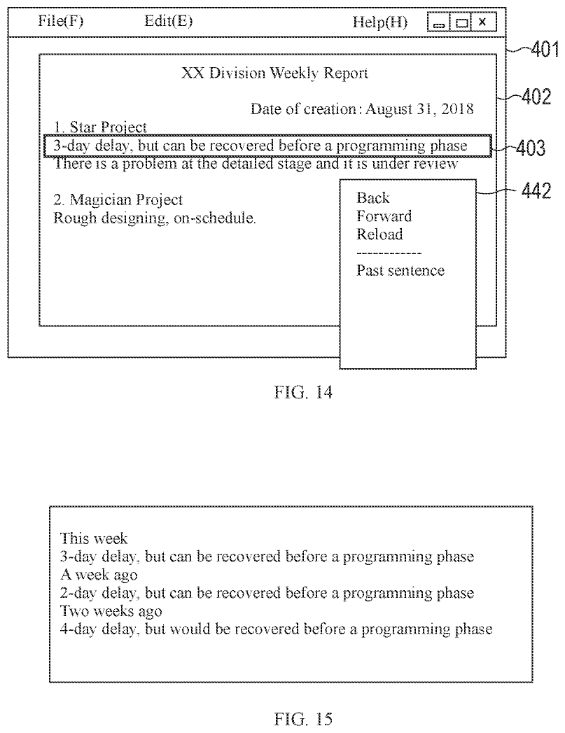

FIG. 12 is a schematic diagram illustrating an example of a method of displaying the determination sentence with a pop-up window. FIGS. 13 and 14 are schematic diagrams illustrating another example of the method of displaying the determination sentence with the pop-up window.

As illustrated in FIG. 12, in Example 3, the notification unit 340 performs a notification by displaying the determination sentence 424 of the second report 404 in a pop-up window 440 on the window 401 of the screen. Thus, the user B can easily grasp the determination sentence 424 visually.

As illustrated in FIG. 13, in a case where the pointer 441 such as a mouse or a cursor is moved (mouse over) onto the confirmation sentence 403, the determination sentence 424 may be displayed by displaying (popping up) the pop-up window 440.

Further, as illustrated in FIG. 14, the determination sentence 424 may be displayed by displaying (popping up) the pop-up window 440 from a context menu 442.

The determination sentence 434 of the third report 425 may be also displayed in addition to the determination sentence 424 of the second report 404.

### EXAMPLE 4

FIG. 15 is a schematic diagram illustrating a case where all determination sentences are displayed in Example 4. As illustrated in FIG. 15, the notification unit 340 performs a notification by displaying the confirmation sentence 403 and all the determination sentences 424 and 434 in the past reports on the screen. Thus, the user B can view a list of the confirmation sentence 403 and the determination sentences 424 and 434 of the past reports.

### EXAMPLE 5

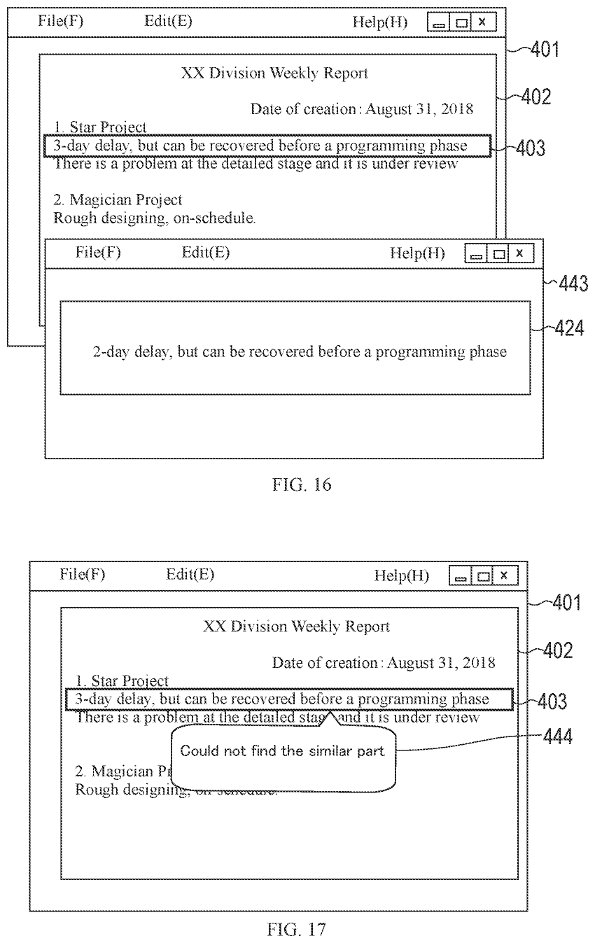

FIG. 16 is a schematic diagram illustrating an example of a method of displaying the determination sentence 424 using another window in Example 5. In Example 5, the notification unit 340 performs a notification by displaying the determination sentence 424 on the screen with another window 443. Thus, the user B can easily grasp the determination sentence 424 visually.

### EXAMPLE 6

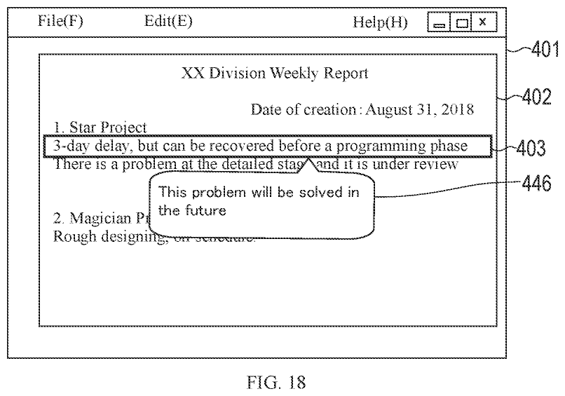

FIGS. 17 and 18 are schematic diagrams illustrating an example and another example of display in a case where it is not possible to find a part similar to the confirmation sentence in Example 6.

As illustrated in FIG. 17, for example, regarding the confirmation sentence 403 of this weekly report, in a case where it is not possible to find a part similar to the confirmation sentence 403 in the past report, the notification unit 340 causes a message indicating that it is not possible to find the similar part to be displayed in a pop-up window 444, for example.

The searching unit 330 can also search for a part similar to the confirmation sentence 403 in a report newer than the first report 402 including the confirmation sentence 403. In a case where it is not possible for the searching unit 330 to find a part similar to the confirmation sentence 403, the notification unit 340 can cause a message indicating that it is not possible to find the similar part to be displayed, for example, in a pop-up window. A possibility that the reason that it is not possible to find the part similar to the confirmation sentence 403 is that the report content of the confirmation sentence 403 is subsequently resolved, and it is not required to be described in the report is high. As illustrated in FIG. 18, the notification unit 340 may be configured to display a message such as “this problem will be solved in the future” or “this problem has already been solved” in a pop-up window 446, for example. Determination of being new and old between a plurality of reports related to each other may be performed based on the date information.

The document processing device 300 in the present embodiment described above exhibits the following effects.

A part similar to the confirmation sentence 403 of the first report 402 is searched for in other documents which are stored in the storage unit 310 and are related to the first report 402. A notification of the determination sentence 424 which has been found by searching and is similar to the confirmation sentence 403 is performed. Therefore, the portion similar to the part selected by the user B in the content of the first report 402 can be searched from the other documents.

The present invention is not limited to only the above-described embodiment, and various modifications can be made within the scope of the claims

For example, the means and method for performing various processes in the document processing device 300 according to the above-described embodiment can be realized by either a dedicated hardware circuit or a programmed computer. The program may be provided, for example, by a computer-readable recording medium such as a CD-ROM (Compact Disc Read Only Memory), or may be provided online via a network such as the Internet. In this case, the program recorded in the computer-readable recording medium is usually transferred to and stored in a storage unit such as a hard disk. The program may be provided as single application software, or may be embedded in the device software as one function of the document processing device 300.

Although embodiments of the present invention have been described and illustrated in detail, it is clearly understood that the same is by way of illustration and example only and not limitation, the scope of the present invention should be interpreted by terns of the appended claims.

1. A document processing device comprising:
a storage unit that stores a plurality of documents related to each other;
a hardware processor that:
causes a user to select a part of a content of a first document among the plurality of documents stored in the storage unit;
searches for a part similar to the selected part of the content of the first document, from documents other than the first document among the plurality of documents; and
notifies of a first part which has been found and is similar to the selected part of the content of the first document.

2. The document processing device according to claim 1,
wherein the hardware processor further searches for a part similar to the first part from documents other than the first document and a second document including the first part among the plurality of documents, and
the hardware processor performs a notification of a second part which has been found and is similar to the first part in the other documents.

3. The document processing device according to claim 1,
wherein each of the plurality of documents includes a body and a title to which the body belongs as the content, the selected part of the content of the first document corresponds to at least a part of the body of the first document, and wherein the hardware processor determines a first title to which the body belongs in the first document,
searches for a second title similar to the first title determined from the other documents, and
searches for a part similar to the selected part of the content of the first document, from a body belonging to the second title found.

4. The document processing device according to claim 3,
wherein the hardware processor further searches for a title similar to a title found from documents other than the first document and a second document including the title found among the plurality of documents.

5. The document processing device according to claim 3,
wherein the hardware processor further searches for a part similar to a second part from documents other than the first document and a second document including the second part similar to the first part, which has been found in the other documents among the plurality of documents.

6. The document processing device according to claim 1, further comprising
a display that displays the document on a screen,
wherein the hardware processor performs the notification by causing the first part to be displayed on the screen with a pop-up window.

7. The document processing device according to claim 6,
wherein the hardware processor acquires position information of a pointer on the screen in a manner that a user operates the pointer displayed on the screen with a pointing device,
wherein, in a case where the pointer moves on the selected part of the content of the first document on the screen, the hardware processor causes the pop-up window to pop up.

8. The document processing device according to claim 6,
wherein the hardware processor causes a context menu to be displayed on the screen, and
in a case where the hardware processor receives an instruction to display the first part from the context menu, the hardware processor causes the pop-up window to pop up.

9. The document processing device according to claim 1, further comprising
a display that displays the document on a screen,
wherein the hardware processor causes the first part to be displayed in a window separate from a window in which the first document is displayed on the screen.

10. The document processing device according to claim 1,
wherein the hardware processor performs a notification of all parts which have been found and are similar to the part of the content of the first document in the other documents.

11. The document processing device according to claim 1,
wherein, in a case where it is not possible that the hardware processor searches for any one part similar to the part of the content of the first document from the other documents, the hardware processor performs a notification that it is not possible to find the part similar to the part of the content of the first document.

12. The document processing device according to claim 1,
wherein the other documents are newer than the first document, and
in a case where it is not possible that the hardware processor searches for any one part similar to the part of the content of the first document from the other documents, the hardware processor performs a notification that it is not possible to find the part similar to the part of the content of the first document.

13. The document processing device according to claim 12,
wherein determination of being new and old between the first document and the other documents is performed based on date information being information regarding a date of the document.

14. A non-transitory recording medium storing a computer readable program causing a computer to perform:
(a) causing a user to select a part of a content of a first document registered in a document processing device;
(b) searching for a part similar to the selected part of the content of the first document from documents other than the first document among a plurality of documents which are registered in the document processing device and relate to each other; and
(c) notifying of a first part which has been found in the searching and is similar to the selected part of the content of the first document.

15. The non-transitory recording medium according to claim 14,
wherein, in the (b) searching, a part similar to the first part is further searched from documents other than the first document and a second document including the first part among the plurality of documents, and
in the (c) notifying, a notification of a second part which has been found in the (b) searching and is similar to the first part in the other documents is performed.

16. The non-transitory recording medium according to claim 14,
wherein each of the plurality of documents includes a body and a title to which the body belongs as the content, the selected part of the content of the first document corresponds to at least a part of the body of the first document, and wherein the (b) searching comprises:
(b1) determining a first title to which the body belongs in the first document and searching for a second title similar to the determined title from the other documents, and
(b2) searching for a part similar to the selected part of the content of the first document, from a body belonging to the second title found in the (b1) determining and searching.

17. The non-transitory recording medium according to claim 16,
wherein the (b) searching further comprises:
(b3) searching for a title similar to a title found in the (b1) determining and searching, from documents other than the first document and a second document including the title among the plurality of documents.

18. The non-transitory recording medium according to claim 16,
wherein the (b) searching further comprises:
(b4) searching for a part similar to a second part found in the (b2) searching, from documents other than the first document and a second document including the second part similar to the first part in the other documents among the plurality of documents.
